(19) United States
(12) Patent Application Publication
(10) Pub. No.: US 2016/0257818 A1
(43) Pub. Date: Sep. 8, 2016

(54) LAYERED PRODUCT AND METHOD FOR PRODUCING SAME, AND LAYERED PRODUCT PRODUCING APPARATUS

(71) Applicants: Daisuke Mezaki, Kanagawa (JP); Takao Hiraoka, Kanagawa (JP); Shinya Seno, Kanagawa (JP)

(72) Inventors: Daisuke Mezaki, Kanagawa (JP); Takao Hiraoka, Kanagawa (JP); Shinya Seno, Kanagawa (JP)

(21) Appl. No.: 14/837,423

(22) Filed: Aug. 27, 2015

(30) Foreign Application Priority Data
Mar. 6, 2015 (JP) 2015-044699

(51) Int. Cl. C09D 4/00; C09D 5/00; B05D 3/00

(52) U.S. Cl. CPC C09D 4/00; B05D 3/007; C09D 5/00

(57) ABSTRACT

Provided is a layered product, including: a base material, and a first layer and a second layer over the base material in this order, wherein the first layer is made of a first photopolymerizable composition containing at least a polymerizable compound having a hydroxyl group, wherein the second layer is made of a second photopolymerizable composition containing at least diethylene glycol dimethacrylate, and wherein an average thickness of the first layer is equal to or greater than 35% of a total average thickness of the first layer and the second layer.

### BACKGROUND OF THE INVENTION

1. Field of the Invention

The present invention relates to a layered product and a method for producing the same, and a layered product producing apparatus.

2. Description of the Related Art

Photopolymerizable compositions and photopolymerizable inkjet inks using (meth)acrylate ester are widely known (see e.g., Japanese Patent Application Laid-Open (JP-A) No. 2004-526820). However, monomers used in the conventional photopolymerizable inkjet inks often have toxicity.

As the results of earnest studies for overcoming this problem, the present inventors have found that some (meth)acrylate esters and (meth)acrylamides are non-problematic in skin sensitization. For example, the present inventors have paid attention to the fact that methacrylate is less toxic than acrylate in skin sensitization, and have proposed inkjet inks that are mainly composed of methacrylate (see e.g., JP-A No. 2012-140593.

### SUMMARY OF THE INVENTION

An object of the present invention is to provide a layered product that is non-problematic in skin sensitization, has excellent close adhesiveness to a metallic surface, and has a high hardness.

A layered product as a solution to the problem described above includes:

a base material; and

a first layer and a second layer over the base material in this order,

wherein the first layer is made of a first photopolymerizable composition that contains at least a polymerizable compound having a hydroxyl group,

wherein the second layer is made of a second photopolymerizable composition that contains at least diethylene glycol dimethacrylate, and

wherein an average thickness of the first layer is equal to or greater than 35% of a total average thickness of the first layer and the second layer.

According to the present invention, it is possible to provide a layered product that is non-problematic in skin sensitization, has excellent close adhesiveness to a metallic surface, and has a high hardness.

### BRIEF DESCRIPTION OF THE DRAWINGS

FIG. 1 is a schematic diagram showing an example of a layered product producing apparatus (ink jetting apparatus) of the present invention.

### DETAILED DESCRIPTION OF THE INVENTION

### (Layered Product)

A layered product of the present invention includes a base material, and a first layer and a second layer over the base material in this order, and further includes other layers according to necessity.

In the present invention, a compound that is negative in skin sensitization refers to a compound that falls under at least one of (1) to (3) below.

(1) A compound of which Stimulation Index (SI value), which indicates a degree of sensitization, results in 3 or less in a skin sensitization test according to an LLNA (Local Lymph Node Assay) method.

(2) A compound that is evaluated to have only minor skin sensitization in a document (e.g., Journal of Oral Rehabilitation 2004 (31) 1173-1177).

(3) A compound that is evaluated to “have no skin sensitization” or to “be negative in skin sensitization” based on MSDS (Material Safety Data Sheet).

As regards (1) above, a component having an SI value of less than 3 is judged to be negative in skin sensitization, as set forth in ‘Functional Materials’, November 2005, Vol. 25, No. 9, P 55. A lower SI value indicates a lower skin sensitization. Hence, in the present invention, it is preferable to use a monomer of which SI value is as low as possible. The SI value is preferably less than 3, more preferably 2 or less, and particularly preferably 1.6 or less.

### <Base Material>

The base material is not particularly limited, and an arbitrary base material may be selected according to the purpose. Examples thereof include paper, plastics, metals, ceramics, and glass, or composite materials thereof.

Absorptive base materials such as quality paper can be expected to exert a permeation-drying effect, which allows use of water-based inks and oil-based inks that do not have a quick-drying property.

Use of a photopolymerizable composition (e.g., an ink) of the present invention having a quick-drying property is more practical over impermeable base materials such as gloss coated paper, plastic films, plastic moldings, ceramics, glass, metals, and rubbers, or composite materials thereof.

Examples of the plastics in the plastic films and the plastic moldings include polyethylenes, polypropylenes, polyethylene terephthalate, polycarbonates, an ABS resin, polyvinyl chlorides, polystyrenes, polyesters, polyamides, and vinyl-based materials, or a composite materials thereof.

In the present invention, a first photopolymerizable composition used for formation of the first layer has excellent close adhesiveness to a surface of a metallic layer made of aluminium, stainless steels, etc., and is hence suitable over metals, or base materials having a metallic layer exposed at the surface thereof.

The first photopolymerizable composition used for formation of the first layer and a second photopolymerizable composition used for formation of the second layer immediately cure upon light irradiation, and are hence suitable over the impermeable base materials.

### <First Layer>

The first layer is a cured product of the first photopolymerizable composition.

### <<First Photopolymerizable Composition>>

The first photopolymerizable composition contains at least a polymerizable compound having a hydroxyl group as a polymerizable monomer. The polymerizable compound having a hydroxyl group is preferably a polymerizable compound having two or more hydroxyl groups, and more preferably a methacrylate compound having two or more hydroxyl groups. In any case, it is preferable that the polymerizable compound be a compound that is negative in skin sensitization.

It is preferable that the first photopolymerization composition contain at least glyceryl monomethacrylate as the methacrylate compound having two or more hydroxyl groups.

By containing the polymerizable compound having a hydroxyl group, the first photopolymerizable composition has a relatively strong interaction with an inorganic surface owing to a polarity attributed to the hydroxyl group in the molecules thereof and can achieve a close adhesiveness to a surface of a metallic layer made of aluminium, stainless steels, etc., and does not corrode metals such as aluminium, stainless steels, etc.

The glyceryl monomethacrylate has properties that it has a sufficiently minor skin sensitization, that it has a relatively strong interaction with an inorganic surface owing to a polarity attributed to the hydroxyl group in the molecules thereof and can achieve a close adhesiveness to a surface of a metallic layer made of aluminium, stainless steels, etc., and that it does not corrode metals such as aluminium, stainless steels, etc.

The glyceryl monomethacrylate has a high viscosity, but can be used as it is as an inkjet ink when used in a commercially available inkjet head having a heating function because it can be thinned in the viscosity by heating. However, there are drawbacks in keeping the inkjet head at a high temperature, such as necessity of keeping the inkjet head in a still-standing state for a certain time from the power-on, necessity of providing a mechanism for keeping not only the inkjet head but also an ink supplying path warm, and so on. These drawbacks will be alleviated if the glyceryl monomethacrylate becomes a certain low viscosity without being heated to such a high temperature.

Hence, it is preferable that the photopolymerizable composition usable also as an inkjet ink contain the glyceryl monomethacrylate in an amount of from 25 parts by mass to 100 parts by mass relative to a total polymerizable monomer amount of 100 parts by mass. In order to ensure the photopolymerizable composition both of a firm close adhesiveness to a surface of a metallic layer and easy handleability as an inkjet ink, it is more preferable that the content of the glyceryl monomethacrylate be from 70 parts by mass to 90 parts by mass relative to the total polymerizable monomer amount of 100 parts by mass.

It is preferable that the first photopolymerizable composition contain diethylene glycol dimethacrylate as a polymerizable monomer, in order to obtain a stable ink jettability.

The first photopolymerizable composition may contain in combination with the polymerizable monomer negative in skin sensitization, any other polymerizable monomer that alone is slightly problematic in skin sensitization or has not been confirmed yet about skin sensitization, as long as such a polymerizable monomer is contained in a range in which the first photopolymerization composition will not cause problems as an ink.

Examples of the any other monomer include ethylene glycol di(meth)acrylate, hydroxypivalic acid neopentyl glycol di(meth)acrylate, polytetramethylene glycol di(meth)acrylate, trimethylol propane (meth)acrylic acid benzoate, diethylene glycol diacrylate, triethylene glycol di(meth)acrylate, tetraethylene glycol di(meth)acrylate, polyethylene glycol di(meth)acrylates [CH₂═CH—CO—(OC₂H₄)—OCOCH═CH₂ (n≈4), and the same monomers with the same formula where n≈9, n≈14, and n≈23, respectively], dipropylene glycol diacrylate, tripropylene glycol diacrylate, polypropylene glycol dimethacrylate [CH₂═C(CH₃)—CO—(OC₃H₆)ₙ—OCOC(CH₃)═CH₂ (n≈7)], 1,3-butanediol diacrylate, 1,4-butanediol diacrylate, 1,6-hexanediol diacrylate, 1,9-nonanediol diacrylate, neopentyl glycol diacrylate, tricyclodecane dimethanol diacrylate, propylene oxide-modified bisphenol A diacrylate, polyethylene glycol diacrylate, dipentaerythritol hexa(meth)acrylate, acryloyl morpholine, 2-hydroxy propyl acrylamide, propylene oxide-modified tetramethylol methane tetra(meth)acrylate, dipentaerythritol hydroxy penta(meth)acrylate, caprolactone-modified dipentaerythritol hydroxy penta(meth)acrylate, ditrimethylol propane tetra(meth)acrylate, pentaerythritol tetra(meth)acrylate, trimethylol propane triacrylate, ethylene oxide-modified trimethylol propane triacrylate, propylene oxide-modified trimethylol propane tri(meth)acrylate, caprolactone-modified trimethylol propane tri(meth)acrylate, pentaerythritol tri(meth)acrylate, tris(2-hydroxy ethyl)isocyanurate tri(meth)acrylate, ethoxylated neopentyl glycol diacrylate, propylene oxide-modified neopentyl glycol diacrylate, propylene oxide-modified glyceryl triacrylate, polyester diacrylate, polyester triacrylate, polyester tetraacrylate, polyester pentaacrylate, polyester polyacrylate, polyurethane di(meth)acrylate, polyurethane tri(meth)acrylate, polyurethane tetra(meth)acrylate, polyurethane penta(meth)acrylate, and polyurethane (meth)acrylate. One of these may be used alone, or two or more of these may be used in combination.

### <<Photopolymerization Initiator>>

When a light source having a high energy such as electron beams, α rays, β rays, γ rays, and X rays is used, polymerization reaction of the first photopolymerizable composition is allowed to proceed without a photopolymerization initiator. However, this fact has been conventionally publicly-known, and will not be described in the present invention in particular, because there is a problem that equipment for such a high energy is very expensive and requires complicated maintenance and management.

Examples of the polymerization initiator as a material generating radicals upon light irradiation include a molecule cleavage-type photopolymerization initiator, and a hydrogen abstraction-type photopolymerization initiator.

Examples of the molecule cleavage-type photopolymerization initiator include 1-hydroxy cyclohexyl phenyl ketone, 2-hydroxy-1-{4-[4-(2-hydroxy-2-methyl-propionyl)benzyl]phenyl}-2-methyl-1-propan-1-one, 2-hydroxy-2-methyl-1-phenyl-propan-1-one, 2,2-dimethoxy-1,2-diphenyl ethan-1-one, 21-[4-(2-hydroxy ethoxy)-phenyl]-2-hydroxy-2-methyl-1-propan-1-one, phenyl glyoxylic acid methyl ester, 2-methyl-1-[4-(methylthio)phenyl]-2-morpholino propan-1-one, 2-benzyl-2-dimethyl amino-1-(4-morpholino phenyl)butanone-1,2-dimethyl amino-2-(4-methyl benzyl)-1-(4-morpholin-4-yl-phenyl)butan-1-one, bis(2,4,6-trimethyl benzoyl)phenyl phosphine oxide, bis(2,6-dimethoxy benzoyl)-2,4,4-trimethyl-pentyl phosphine oxide, 2,4,6-trimethyl benzoyl phosphine oxide, 1,2-octanedione-[4-(phenylthio)-2-(o-benzoyl oxime)], ethanone-1-[9-ethyl-6-(2-methyl benzoyl)-9H-carbazol-3-yl]-1-(O-acetyl oxime), [4-(methyl phenylthio)phenyl]phenyl methanone, and oligo {2-hydroxy-2-methyl-1-[4-(1-methyl vinyl)phenyl]propanone}. One of these may be used alone, or two or more of these may be used in combination.

Examples of the hydrogen abstraction-type photopolymerization initiator include: benzophenone-based compounds such as benzophenone, methyl benzophenone, methyl-2-benzoyl benzoate, 4-benzoyl-4′-methyl diphenyl sulfide, and phenyl benzophenone; and thioxanthone-based compounds such as 2,4-diethyl thioxanthone, 2-chlorothioxanthone, isopropyl thioxanthone, and 1-chloro-4-propyl thioxanthone. One of these may be used alone, or two or more of these may be used in combination.

The content of the photopolymerization initiator is not particularly limited, and may be selected appropriately according to the purpose. However, it is preferably from 1% by mass to 20% by mass, and more preferably from 5% by mass to 10% by mass relative to the total amount of the polymerizable compound.

### <<Polymerization Accelerator>>

An amine compound may be used as the polymerization accelerator in combination with the photopolymerization initiator.

Examples of the amine compound include ethyl p-dimethylaminobenzoate, 2-ethylhexyl p-dimethylaminobenzoate, methyl p-dimethylaminobenzoate, benzoic acid-2-dimethyl aminoethyl, and butoxy ethyl p-dimethylaminobenzoate.

### <<Other Components>>

Examples of other components include colorants, polymerization inhibitors, surfactants, solvents, photosensitizers, and polar group-containing polymeric pigment dispersants.

### —Colorant—

The colorant may be an inorganic pigment or an organic pigment. The type of the inorganic pigment or the organic pigment to be used may be varied according to the necessity in consideration of physical properties of the ink, and so on.

Examples of black pigments include carbon blacks produced by a furnace method or a channel method.

Examples of yellow pigments include Pig. Yellow-based pigments, such as Pigment Yellow 1, Pigment Yellow 2, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 75, Pigment Yellow 83, Pigment Yellow 93, Pigment Yellow 95, Pigment Yellow 97, Pigment Yellow 98, Pigment Yellow 114, Pigment Yellow 120, Pigment Yellow 128, Pigment Yellow 129, Pigment Yellow 138, Pigment Yellow 150, Pigment Yellow 151, Pigment Yellow 154, Pigment Yellow 155, and Pigment Yellow 180.

Examples of magenta pigments include Pig. Red-based pigments, such as Pigment Red 5, Pigment Red 7, Pigment Red 12, Pigment Red 48 (Ca), Pigment Red 48 (Mn), Pigment Red 57 (Ca), Pigment Red 57:1, Pigment Red 112, Pigment Red 122, Pigment Red 123, Pigment Red 168, Pigment Red 184, Pigment Red 202, and Pigment Violet 19.

Examples of cyan pigments include Pig. Blue-based pigments, such as Pigment Blue 1, Pigment Blue 2, Pigment Blue 3, Pigment Blue 15, Pigment Blue 15:3, Pigment Blue 15:4, Pigment Blue 16, Pigment Blue 22, Pigment Blue 60, Vat Blue 4, and Vat Blue 60.

Examples of white pigments include: salts of a sulfuric acid with alkaline-earth metals, such as barium sulfate; salts of a carbonic acid with alkaline-earth metals, such as calcium carbonate; silicas such as finely-divided silicate, and synthetic silicate salts; calcium silicate; alumina; alumina hydrate; titanium oxide; zinc oxide; talc; and clay.

### —Polymerization Inhibitor—

Examples of the polymerization initiator include 4-methoxy-1-naphthol, methyl hydroquinone, hydroquinone, t-butyl hydroquinone, di-t-butyl hydroquinone, methoquinone, 2,2′-dihydroxy-3,3′-di(a-methyl cyclohexyl)-5,5′-dimethyl diphenyl methane, p-benzoquinone, di-t-butyl diphenyl amine, 9,10-di-n-butoxy anthracene, and 4,4′-[1,10-dioxo-1, 10-decane diylbis(oxy)]bis[2,2,6,6-tetramethyl]-1-piperidinyloxy. One of these may be used alone, or two or more of these may be used in combination.

### —Surfactant—

The surfactant is not particularly limited, and an arbitrary surfactant may be selected according to the purpose. Examples thereof include long-chain fatty acid-based surfactants, silicone-based surfactants, and fluorosurfactants. One of these may be used alone, or two or more of these may be used in combination.

### —Solvent—

The first photopolymerizable composition may have too high a viscosity to be jetted as the inkjet ink, when it is in the state that the polymerizable compound, the photopolymerization initiator, the colorant, and so on are blended. In this case, it is preferable to dilute the first photopolymerization composition with a solvent. However, in the present invention, a jettable photopolymerizable composition can be obtained without such a solvent.

The solvent preferably has a boiling point of from 160° C. to 190° C. in terms of curability, and ink jettability.

Examples of the solvent include methanol, ethanol, 2-propanol, ether, acetone, 2-butanone, xylene, ethyl ethoxypropionate, ethyl acetate, cyclohexanone, diethylene glycol monomethyl ether, diethylene glycol, monoethyl ether, γ-butyl lactone, ethyl lactate, cyclohexane methyl ethyl ketone, toluene, ethyl ethoxy propionate, polymethacrylate or propylene glycol monomethyl ether acetate, ethylene glycol monomethyl ether, diethylene glycol, and triethylene glycol monobutyl ether. One of these may be used alone, or two or more of these may be used in combination.

### <<Physical Property>>

Among inkjet heads, there are those that have a high jetting power and can handle even high-viscosity inks, and those that have a function for a wide-range temperature control. Under such circumstances, the viscosity of the first photopolymerizable composition is preferably from 2 mPa·s to 150 mPa·s at 25° C., and more preferably from 5 mPa·s to 18 mPa·s in consideration of jetting at 25° C. When a temperature control function of the inkjet head is available, it may be possible to lower the viscosity of the ink when the viscosity of the ink at 25° C. is too high, by heating the inkjet head where necessary. When the heating condition is assumed to be 45° C. or 60° C., the viscosity at 45° C. or 60° C. is preferably from 5 mPa·s to 18 mPa·s.

The viscosity was measured with a cone-and-plate rotary viscometer VISCOMETER TV-22 manufactured by Toki Sangyo Co., with the temperature of hemathermal circulating water set to 25° C., 45° C., and 60° C. VISCOMATE VM-150III was used for adjusting the temperature of the circulating water. The temperature of 25° C. assumed common room temperature conditions, and the temperature of 60° C. assumed the specifications of commercially available inkjet heads having a heating capability, such as GEN4 manufactured by Ricoh Printing Systems, Ltd.

A static surface tension of the first photopolymerizable composition at 25° C. is preferably from 20 mN/m to 40 mN/m, and more preferably from 28 mN/m to 35 mN/m.

The static surface tension was measured with a static surface tensiometer (CBVP—Z type manufactured by Kyowa Interface Science Co., Ltd.) at 25° C. The static surface tension assumed the specifications of commercially available inkjet heads such as GEN4 manufactured by Ricoh Printing Systems, Ltd.

### <<Curing>>

The first layer can be formed over the base material by curing the first photopolymerizable composition.

It is preferable to perform the curing by irradiation of ultraviolet rays as active energy rays. Details of the curing will be described in a method for producing a layered product described below.

The average thickness of the first layer is not particularly limited, and may be appropriately selected according to the purpose. However, it is preferably 3 μm or greater, more preferably 30 μm or greater, and yet more preferably from 30 μm to 200 μm.

A neat coating film can be produced by an inkjet method when it is formed into the average thickness of 3 μm or greater. A coating film having the average thickness of 200 μm or less can be cured to a favorable state.

The average thickness of the first layer is an average value of the thickness values measured at arbitrary ten positions with, for example, a micrometer (manufactured by Mitutoyo Corporation).

### <Second Layer>

The second layer is a cured product of the second photopolymerizable composition.

### <<Second Photopolymerizable Composition>>

The second photopolymerizable composition contains a (meth)acrylic acid ester compound that is preferably negative in skin sensitization as a polymerizable monomer, contains at least diethylene glycol dimethacrylate as the (meth)acrylic acid ester compound, may further contain a triazine compound as a photopolymerization initiator, and further contains other components according to necessity.

### —(Meth)Acrylic Acid Ester Compound—

The second photopolymerization composition contains at least diethylene glycol dimethacrylate as the (meth)acrylic acid ester compound, and further contains any other (meth)acrylic acid ester compound according to necessity.

The diethylene glycol dimethacrylate is negative in skin sensitization, and may be a commercially available product, examples of which include “2G” manufactured by Shin-Nakamura Chemical Co., Ltd. (with the SI value of 1.1).

As the any other (meth)acrylic acid ester compound, those that are negative in skin sensitization, and those that alone are slightly problematic in skin sensitization or have not been confirmed yet about skin sensitization may be used. Examples of such compounds include ethylene glycol di(meth)acrylate, hydroxypivalic acid neopentyl glycol di(meth)acrylate, γ-butyrolactone acrylate, isobornyl (meth)acrylate, formalized trimethylol propane mono(meth)acrylate, polytetramethylene glycol di(meth)acrylate, trimethylol propane (meth)acrylic acid benzoate, diethylene glycol diacrylate, triethylene glycol di(meth)acrylate, tetraethylene glycol di(meth)acrylate, polyethylene glycol di(meth)acrylates [CH₂═CH—CO—(OC₂H₄)ₙ—OCOCH═CH₂ (n≈4), and the same compounds with the same formula where n≈9, n≈14, and n≈23, respectively], dipropylene glycol di(meth)acrylate, tripropylene glycol di(meth)acrylate, polypropylene glycol dimethacrylate [CH₂═C(CH₃)—CO—(OC₃H₆)ₙ—OCOC(CH₃)═CH₂ (n≈7)], 1,3-butanediol diacrylate, 1,4-butanediol di(meth)acrylate, 1,6-hexanediol di(meth)acrylate, 1,9-nonanediol di(meth)acrylate, neopentyl glycol di(meth)acrylate, tricyclodecane dimethanol di(meth)acrylate, propylene oxide-modified bisphenol A di(meth)acrylate, polyethylene glycol di(meth)acrylate, dipentaerythritol hexa(meth)acrylate, (meth)acryloyl morpholine, 2-hydroxypropyl (meth)acrylamide, propylene oxide-modified tetramethylol methane tetra(meth)acrylate, dipentaerythritol hydroxy penta(meth)acrylate, caprolactone-modified dipentaerythritol hydroxy penta(meth)acrylate, ditrimethylol propane tetra(meth)acrylate, pentaerythritol tetra(meth)acrylate, trimethylol propane triacrylate, ethylene oxide-modified trimethylol propane triacrylate, propylene oxide-modified trimethylol propane tri(meth)acrylate, caprolactone-modified trimethylol propane tri(meth)acrylate, pentaerythritol tri(meth)acrylate, tris(2-hydroxy ethyl)isocyanurate tri(meth)acrylate, ethoxylated neopentyl glycol di(meth)acrylate, propylene oxide-modified neopentyl glycol di(meth)acrylate, propylene oxide-modified glyceryl tri(meth)acrylate, polyester di(meth)acrylate, polyester tri(meth)acrylate, polyester tetra(meth)acrylate, polyester penta(meth)acrylate, polyester poly(meth)acrylate, N-vinyl caprolactam, N-vinyl pyrrolidone, N-vinyl formamide, polyurethane di(meth)acrylate, polyurethane tri(meth)acrylate, polyurethane tetra(meth)acrylate, polyurethane penta(meth)acrylate, and polyurethane poly(meth)acrylate. One of these may be used alone, or two or more of these may be used in combination.

A mass ratio (A/B) of the diethylene glycol dimethacrylate (A) to the any other (meth)acrylic acid ester compound (B) varies depending on various conditions such as curability, viscosity, and so on, is not particularly limited, and may be appropriately selected according to the purpose. However, it is preferably from 100/0 to 3/97, and more preferably from 95/5 to 10/90.

### <<Photopolymerization Initiator>>

The photopolymerization initiator may be the same photopolymerization initiator as used in the first photopolymerization composition, and is not particularly limited. However, a preferable example thereof is a combination of 1-hydroxy cyclohexyl phenyl ketone and 2-hydroxy-1-{4-[4-(2-hydroxy-2-methyl-propiony)benzyl]phenyl}-2-methyl-1-propan-1-one. A combined use of them enables a high curability that has not been reached yet conventionally, and significant suppression of yellowing at the same time.

The content of the photopolymerization initiator is preferably 10 parts by mass or greater, and more preferably from 10 parts by mass to 20 parts by mass relative to 100 parts by mass of the (meth)acrylic acid ester compound, because the photopolymerization initiator can be used at a low viscosity, and with a view to imparting a practically sufficient curability.

### <<Triazine Compound>>

The triazine compound is not particularly limited, and an arbitrary triazine compound may be selected according to the purpose. However, a preferable example thereof is 2-[2-hydroxy-4-(1-octyloxy carbonyl ethoxy)phenyl]-4,6-bis(4-phenyl phenyl)-1,3,5-triazine.

Use of the triazine compound leads to significant suppression of yellowing, and a practical level of weatherability.

The content of the triazine compound is from 0.5 parts by mass to 0.9 parts by mass relative to 100 parts by mass of the (meth)acrylic acid ester in the second photopolymerizable composition, in terms of weatherability, curability, and viscosity suppression.

### <<Hindered Amine Compound>>

It is preferable that the second photopolymerizable composition contain a hindered amine compound in order to maintain the strength of the second layer and suppress the degree of yellowing even more.

The hindered amine compound is not particularly limited, and an arbitrary hindered amine compound may be selected according to the purpose. Examples thereof include sebacic acid bis[2,2,6,6-tetramethyl-1-(octyloxy)piperidin-4-yl](“TINUVIN 123” manufactured by BASF GmbH) (with no skin sensitization according to evaluation based on MSDS), and a mixture of sebacic acid bis[1,2,2,6,6-pentamethyl-piperidin-4-yl] and sebacic acid [1,2,2,6,6-pentamethyl-piperidin-4-yl]methyl (“TINUVIN 292” manufactured by BASF GmbH) (with skin sensitization according to evaluation based on MSDS).

Further, a plurality of kinds of hindered amine compounds may be used in combination. For example, it is preferable to use a hindered amine compound that has a stronger anti-deterioration effect and a hindered amine compound that has a weaker anti-deterioration effect in combination.

The content of the hindered amine compound is preferably from 0.5 parts by mass to 0.9 parts by mass relative to 100 parts by mass of the (meth)acrylic acid ester, because it is possible to maintain the strength of the second layer and suppress yellowing at the same time.

### <<Other Components>>

Examples of the other components include colorants, polymerization inhibitors, surfactants, photosensitizers, and polar group-containing polymeric pigment dispersants.

The colorants, the polymerization inhibitors, the surfactants, the photosensitizers, and the polar group-containing polymeric pigment dispersants may be the same as those used in the first photopolymerization composition.

### <<Physical Property>>

The viscosity of the second photopolymerization composition at 25° C. is preferably from 3 mPa·s to 40 mPa·s, and more preferably from 3 mPa·s to 35 mPa·s at 25° C. The viscosity of the second photopolymerization composition at 60° C. is preferably from 7 mPa·s to 15 mPa·s, and more preferably from 10 mPa·s to 12 mPa·s.

The viscosities at 25° C. and 60° C. were measured with a cone-and-plate rotary viscometer VISCOMETER TV-22 manufactured by Toki Sangyo Co., with the temperature of hemathermal circulating water set to 25° C. and 60° C. VISCOMATE VM-150III was used for adjusting the temperature of the circulating water. The temperature of 25° C. assumed common room temperature conditions, and the temperature of 60° C. assumed the specifications of commercially available inkjet heads having a heating capability, such as GEN4 manufactured by Ricoh Printing Systems, Ltd.

A static surface tension of the second photopolymerizable composition at 25° C. is preferably from 20 mN/m to 40 mN/m, and more preferably from 28 mN/m to 35 mN/m.

The static surface tension was measured with a static surface tensiometer (CBVP—Z type manufactured by Kyowa Interface Science Co., Ltd.) at 25° C. The static surface tension assumed the specifications of commercially available inkjet heads such as GEN4 manufactured by Ricoh Printing Systems, Ltd.

### (Layered Product Material Set)

The layered product material set contains a first photopolymerizable composition containing at least a polymerizable compound having a hydroxyl group, and a second photopolymerizable composition containing at least diethylene glycol dimethacrylate, and further contains other components according to necessity.

The first photopolymerization composition and the second photopolymerization composition may be the same as the first photopolymerization composition and the second photopolymerization composition in the layered product described above.

### <<Cured Product>>

The second layer can be formed by curing the second photopolymerizable composition.

It is preferable to perform the curing by irradiation of ultraviolet rays as active energy rays. Details of the curing will be described in a method for producing a layered product described below.

The average thickness of the second layer is not particularly limited, and may be appropriately selected according to the purpose. However, it is preferably 3 μm or greater, more preferably 30 μm or greater, and yet more preferably from 30 μm to 200 μm.

A neat coating film can be produced by an inkjet method when it is formed into the average thickness of 3 μm or greater. A coating film having the average thickness of 200 μm or less can be cured to a favorable state.

The average thickness of the second layer is an average value of the thickness values measured at arbitrary ten positions with, for example, a micrometer (manufactured by Mitutoyo Corporation).

In the present invention, the average thickness of the first layer is equal to or greater than 35%, preferably equal to or greater than 65%, and more preferably from 65% to 90% of a total average thickness of the first layer and the second layer. When the ratio of the average thickness of the first layer relative to the total average thickness of the first layer and the second layer is 35% or greater, a favorable close adhesiveness can be obtained.

### (Method for Producing Layered Product)

A method for producing a layered product of the present invention includes a first photopolymerization composition delivering step and a second photopolymerizable composition delivering step, preferably includes a first layer forming step and a second layer forming step, and further contains other steps according to necessity.

The first layer, which is cured product of the first photopolymerization composition, is formed to have an average thickness that is equal to or greater than 35% of the total average thickness.

### <First Photopolymerization Composition Delivering Step>

The first photopolymerization composition delivering step is a step of delivering the first photopolymerizable composition onto a base material.

The method for delivering the first photopolymerizable composition is not particularly limited, and an arbitrary method may be selected according to the purpose. However, either inkjet methods or coating methods are preferable. Of these, inkjet methods are particularly preferable.

The inkjet methods are not particularly limited, and an arbitrary method may be selected according to the purpose. In terms of inkjet head driving methods, on-demand heads that utilize a piezoelectric element actuator using PZT and so on, a thermal energy driving scheme, an electrostatic actuator, or the like may be used, or continuous-jetting, charge-control heads may be used.

The coating methods are not particularly limited, and an arbitrary method may be selected according to the purpose. Examples thereof include blade coating, gravure coating, gravure offset coating, wire bar coating, bar coating, roller coating, knife coating, air knife coating, comma coating, U-comma coating, AKKU coating, smoothing coating, micro gravure coating, reverse roller coating, 4-roller or 5-roller coating, dip coating, curtain coating, slide coating, and die coating. Among these, wire bar coating and roller coating are preferable.

### <Second Photopolymerizable Composition Delivering Step>

The second photopolymerizable composition delivering step is a step of delivering the second photopolymerizable composition containing at least diethylene glycol dimethacrylate onto a layer made of the first photopolymerizable composition.

The method for delivering the second photopolymerizable composition is the same as the method for delivering the first photopolymerizable composition.

It is preferable to deliver the second photopolymerizable composition before the delivered first photopolymerizable composition has cured, because the second layer can be formed neatly without the second layer being repelled by the first layer.

### <First Layer Forming Step and Second Layer Forming Step>

The layer forming steps are steps of forming the first layer and the second layer by curing the first photopolymerizable composition and the second photopolymerizable composition.

The curing can be performed by irradiation of ultraviolet rays as active energy rays. The light source for irradiation of ultraviolet rays as the active energy rays is not particularly limited, and an arbitrary light source may be selected according to the purpose. Light having a waveform of from 350 nm to 450 nm is preferable.

The amount of irradiation of ultraviolet rays as the active energy rays is not particularly limited, and may be appropriately selected according to the purpose. However, it is preferably from 10 mJ/cm² to 20,000 mJ/cm², and more preferably from 50 mJ/cm² to 15,000 mJ/cm². An amount of irradiation of ultraviolet rays that is within the above value range enables a sufficient curing reaction.

The light source of the ultraviolet irradiation is not particularly limited, and an arbitrary light source may be selected according to the purpose. Examples thereof include lamps such as metal halide lamps, xenon lamps, carbon-arc lamps, chemical lamps, low-pressure mercury lamps, and high-pressure mercury lamps. Examples of commercially available products of the light source include H LAMP, D LAMP, and V LAMP manufactured by Fusion System.

Ultraviolet irradiation may be performed with ultraviolet light-emitting semiconductor elements such as an ultraviolet light-emitting diode (ultraviolet LED), and an ultraviolet light-emitting semiconductor laser.

### <Other Steps>

The other steps are not particularly limited, and arbitrary steps may be selected according to the purpose. Examples thereof include a washing step, a conveying step, and a controlling step.

### (Layered Product Producing Apparatus)

A layered product producing apparatus of the present invention includes:

a first storing unit configured to store the first photopolymerization composition containing at least a polymerizable compound having a hydroxyl group;

a second storing unit configured to store the second photopolymerization composition containing at least diethylene glycol dimethacrylate;

a first delivering unit configured to deliver the first photopolymerizable composition onto a base material;

a second delivering unit configured to deliver the second photopolymerizable composition onto a layer made of the first photopolymerizable composition; and

a curing unit configured to cure the first photopolymerizable composition and the second photopolymerizable composition that are delivered,

wherein the layered product producing apparatus includes other units according to necessity.

Examples of the first storing unit and the second storing unit include an ink cartridge, an ink tank, and an ink bag.

Examples of the first delivering unit and the second delivering unit include a continuous jetting type and an on-demand type. Examples of the on-demand type include a piezo system, a thermal system, and an electrostatic system.

Examples of the curing unit include an ultraviolet irradiating device.

The other units are not particularly limited, and arbitrary units may be selected according to the purpose. Examples thereof include a washing unit, a conveying unit, and a controlling unit.

It is preferable that a scratch hardness of the layered product of the present invention according to a pencil process specified in JIS-K-5600-5-4 be H or greater, and that a close adhesiveness evaluation thereof according to a crosscut method specified in JIS-K-5600-5-6 be “0”.

### EXAMPLES

Examples of the present invention will be described below. The present invention is not limited to these Examples.

### <Method for Evaluating SI Value>

The SI value was measured according to a skin sensitization test by LLNA (Local Lymph Node Assay) method as described below.

### [Test Materials]

### <<Positive Control Substance>>

α-hexyl cinnamaldehyde (HCA manufactured by Wako Pure Chemical Industries, Ltd.) was used as the positive control substance.

### <<Medium>>

A mixture liquid obtained by mixing acetone (manufactured by Wako Pure Chemical Industries, Ltd.) and an olive oil (manufactured by Fujimi Pharmaceutical Co., Ltd.) at a volume ratio of 4:1 was used as the medium.

### <<Animals Used>>

Female mice were subjected to eight days of conditioning to each of the test article, the positive control, and the medium control including six days of quarantine. During the quarantine and conditioning period, nothing unusual was observed from any of the animals.

Using the body weights of the animals measured two days before sensitization was started, the animals were divided into two groups (4 mice/group) in a manner that the body weight of each individual would be within ±20% of the mean body weight of the whole group according to a body weight stratified random sampling method. The ages in weeks of the animals when sensitization was started were from 8 to 9 weeks old. Any animals that did not fall into any group by the grouping were excluded from the test.

Throughout the test period, the animals used were identified with an oil-based ink applied to their tails, and their cages were identified with labels.

### <<Rearing Conditions>>

Throughout the whole rearing period including the quarantine and conditioning period, the animals used were reared in a barriered animal room set to a temperature of from 21° C. to 25° C., a relative humidity of from 40% to 70%, an air change rate of from 10 changes/hour to 15 changes/hour, and a light-dark cycle of 12 hour-intervals (light-on at 7 o'clock, and light-out at 19 o'clock).

The rearing cages were polycarbonate-made cages. The number of animals used reared in each cage was 4 mice/cage.

Feeding stuff used was a solid feed for experimental animals named MF (manufactured by Oriental Yeast Co., Ltd.), and freely fed to the animals used. Drinking water was tap water to which sodium hypochlorite was added to a chlorine concentration of about 5 ppm (PURELOX manufactured by Oyalox Co., Ltd.), and freely fed to the animals used with water feed bottles. Animal bedding used was SUNFLAKE (fir tree, power planer shavings, manufactured by Charles River Laboratories Japan, Inc.). The feeding stuff and rearing tools were each sterilized in an autoclave (at 121° C. for 30 minutes).

The cages and bedding were replaced at the grouping, and on the day of auricular lymph node extraction (when the animals were removed from the animal room). The water feed bottles and racks were replaced at the grouping.

### [Test Method]

### <<Group Constitution>>

The group constitution used in the SI value measurement test is shown in Table 1.

TABLE 1

| | | | Number of | Number of |
|---|---|---|---|---|
| | | Sensitizing | times of | animals |
| Test | Sensitizing | dose | sensitizing | (animal |
| group | substance | (μL/auricle) | treatment | number) |
| Medium | Medium only | 25 | Once/day × 3 | 4 (1-4) |
| control | | | days | |
| group | | | | |
| Positive | 25.0% HCA | 25 | Once/day × 3 | 4 (5-8) |
| control | | | days | |
| group | | | | |

### [Preparation]

### <<Test Article>>

Weighing conditions for the test particle are shown in Table 2. The test article was weighed out in a measuring flask, and fixed to a constant volume of 1 mL by adding a medium to the flask. The prepared liquid was put in a light-blocked airtight container (made of glass).

TABLE 2

| | Prepared concentration | Amount of test article |
|---|---|---|
| | (w/v %) | weighed out (g) |
| Test article | 50.0 | 0.5 |

### <<Positive Control Substance>>

HCA was accurately weighed out in 0.25 g, and prepared as a 25.0 w/v % liquid in an amount of 1 mL by addition of a medium. The prepared liquid was put in a light-blocked airtight container (made of glass).

### <<BrdU>>

5-bromo-2′-deoxyuridine (BrdU manufactured by Nacalai Tesque, Inc.) was accurately weighed out in 200 mg in a measuring flask, and by ultrasonic irradiation, dissolved in a saline (manufactured by Otsuka Pharmaceutical Co., Ltd.) added thereto. After this, the obtained liquid was fixed to a constant volume of 20 mL, and prepared as a 10 mg/mL liquid (a BrdU preparation liquid). The preparation liquid was filtered and sterilized through a sterilization filter, and put in a sterilized container.

### <<Preparation Timing and Storage Period>>

The positive control substance preparation liquid was prepared on the day before the sensitization start day, and stored in a cold place at times other than use. The medium and the test article preparation liquid were each prepared on the day of sensitization. The BrdU liquid was prepared two days before administration, and stored in a cold place until the day of administration.

### [Sensitization and BrdU Administration]

### <<Sensitization>>

The prepared liquids of the test article and positive control substance and the medium were applied to both auricles of the animals in an amount of 25 μL for each. A micropipetter was used for the application. This operation was performed once a day on three consecutive days.

### <<BrdU Administration>>

The BrdU preparation liquid was administered into the abdominal cavity of the animals once about 48 hours after the final sensitization in an amount of 0.5 mL per animal.

### [Observation and Tests]

### <<Performance Status>>

All animals used for the test were observed more than once a day from the sensitization start day until the auricular lymph node extraction day (i.e., the day when the animals were removed from the animal room). The observation days were counted in a manner that the sensitization start day was Day 1.

### <<Measurement of Body Weight>>

The body weight was measured on the sensitization start day and the auricular lymph node extraction day (i.e., the day when the animals were removed from the animal room). The mean and standard error of the body weight per group were calculated.

### <<Auricular Lymph Node Extraction and Weight Measurement>>

About 24 hours after the BrdU administration, the animals were euthanized, and the auricular lymph nodes were extracted, and from which surrounding tissues were removed. Both auricular lymph nodes were weighed simultaneously. The mean and standard error of the weight of the auricular lymph nodes per group were calculated. After the weight measurement, the auricular lymph nodes were freeze-stored per individual in a bio-medical freezer set to −20° C.

### <<Measurement of Amount of BrdU Intake>>

After the auricular lymph nodes were returned to room temperature, they were ground with a saline added, and suspended. The suspension liquid was filtered and then dispensed into a 96-well microplate 3 wells/individual, and the amount of BrdU intake was measured according to ELISA method. The reagent used was a commercially available kit (CELL PROLIFERATION ELISA, BRDU, COLORIMETRIC, CAT. NO. 1647229 manufactured by Roche Diagnostics gmbh). The optical densities (OD 370 nm to OD 492 nm, an amount of BrdU intake) obtained with a multi-plate reader (FLUOSTAR OPTIMA manufactured by BMG LABTECH Inc.) from the three wells per individual were averaged as a BrdU measurement of each individual.

### [Result Evaluation]

### <<Calculation of Stimulation Index (SI)>>

The BrdU measurement of each individual was divided by the mean BrdU measurement of the medium control group, to calculate the SI value of each individual. The SI value of each test group was the mean of the SI values of the individuals. The SI values were rounded off at the second decimal place, and expressed to the first decimal place.

$$SI = \frac{\begin{matrix}Mean BrdU measurement \\ of each individual ( mean of 3 wells )\end{matrix}}{\begin{matrix}Mean BrdU measurement of \\ medium control group ( mean of 4 mice )\end{matrix}}$$

### Example 1

### Production of Layered Product

### <<Composition of First Photopolymerizable Compositions (A) and (B)>>

Glyceryl monomethacrylate (“BLEMMER GLM” manufactured by NOF Corporation), evaluated to be minor in a document)
Glyceryl dimethacrylate (“NK ESTER 701” manufactured by Shin-Nakamura Chemical Co., Ltd., SI value=1.2)
Hydroxyethyl acrylamide (“HEAA” manufactured by Kohjin C., Ltd., evaluated to be negative in skin sensitization based on MSDS)
Diethylene glycol dimethacrylate (“2G” manufactured by Shin-Nakamura Chemical Co., Ltd., SI value=1.1)
1-hydroxy cyclohexyl phenyl ketone (“IRGACURE 184” manufactured by BASF GmbH, evaluated to be negative in skin sensitization based on MSDS)
2-hydroxy-2-methyl-1-phenyl propanone (“IRGACURE 1173” manufactured by BASF GmbH, evaluated to be negative in skin sensitization based on MSDS)

### [Preparation of First Photopolymerizable Composition (A)]

The 1-hydroxy cyclohexyl phenyl ketone (10 parts by mass) was added to and mixed with a mixture of the glyceryl monomethacrylate (75 parts by mass) and the diethylene glycol dimethacrylate (25 parts by mass), to thereby prepare a first photopolymerizable composition (A).

### [Preparation of First Photopolymerizable Composition (B)]

The 2-hydroxy-2-methyl-1-phenyl propanone (10 parts by mass) was added to and mixed with a mixture of the glyceryl dimethacrylate (35 parts by mass), the diethylene glycol dimethacrylate (35 parts by mass), and the hydroxyethyl acrylamide (30 parts by mass), to thereby prepare a first photopolymerizable composition (B).

The viscosity of the obtained first photopolymerizable composition (A) at 25° C. was 57 mPa·s, and the viscosity of the obtained first photopolymerizable composition (B) at 25° C. was 78 mPa·s. The viscosities were measured with a cone-and-plate rotary viscometer VISCOMETER TV-22 manufactured by Toki Sangyo Co., with the temperature of hemathermal circulating water set to 25° C.

### <<Composition and Content of Second Photopolymerizable Composition (A)>>

| | |
|---|---|
| Diethylene glycol dimethacrylate (“2G” | 70 parts by mass |
| manufactured by Shin-Nakamura Chemical Co., | |
| Ltd., SI value = 1.1) | |
| Ethylene oxide-modified bisphenol A diacrylate | 30 parts by mass |
| (“A-BPE-10” manufactured by Shin-Nakamura | |
| Chemical Co., Ltd., SI value = 1.2) | |
| 2-hydroxy-2-methyl-1-phenyl propanone | 15 parts by mass |

### <<Composition and Content of Second Photopolymerizable Composition (B)>>

| | |
|---|---|
| Diethylene glycol dimethacrylate (“2G” manufactured | 70 parts by mass |
| by Shin-Nakamura Chemical Co., Ltd., SI value = 1.1) | |
| Caprolactone-modified dipentaerythritol hexaacrylate | 30 parts by mass |
| (“DPCA60” manufactured by Nippon Kayaku Co., | |
| Ltd., evaluated to be negative in skin sensitization | |
| based on MSDS) | |
| 1-hydroxy cyclohexyl phenyl ketone | 15 parts by mass |
| (“IRGACURE 184” manufactured by BASF GmbH, | |
| evaluated to be negative in skin sensitization | |
| based on MSDS) | |
| 2-hydroxy-1-{4-[4-(2-hydroxy-2-methyl | 2.5 parts by mass |
| propionyl)benzyl]phenyl}-2-methyl-1-propan-1-one | |
| (“IRGACURE 127” manufactured by BASF GmbH, | |
| evaluated to be negative in skin sensitization | |
| based on MSDS) | |
| 2-[2-hydroxy-4-(1-octyloxy carbonyl | 0.7 parts by mass |
| ethoxy)phenyl]-4.6-bis(4-phenyl phenyl)-1,3,5-triazine | |
| (“TINUVIN 479” manufactured by BASF GmbH, | |
| evaluated to be negative in skin sensitization | |
| based on MSDS) | |
| sebacic acid bis[2,2,6,6-tetramethyl-1- | 0.7 parts by mass |
| (octyloxy)piperidin-4-yl] (“TINUVIN 123” | |
| manufactured by BASF GmbH, | |
| evaluated to be negative in skin sensitization | |
| based on MSDS) | |

### [Preparation of Second Photopolymerizable Composition (A)]

The 2-hydroxy-2-methyl-1-phenyl propanone was added to and mixed with a mixture of the diethylene glycol dimethacrylate and the ethylene oxide-modified bisphenol A diacrylate, to thereby prepare a second photopolymerizable composition (A).

The viscosity of the obtained second photopolymerizable composition (A) at 25° C. was 24 mPa·s. The viscosity was measured with a cone-and-plate rotary viscometer VISCOMETER TV-22 manufactured by Toki Sangyo Co., with the temperature of hemathermal circulating water set to 25° C.

### [Preparation of Second Photopolymerizable Composition (B)]

The 1-hydroxy cylohexyl phenyl ketone, the 2-hydroxy-1-{4-[4-(2-hydroxy-2-methyl propionyl)benzyl]phenyl}-2-methyl-1-propan-1-one, the 2-[2-hydroxy-4-(1-octyloxy carbonyl ethoxy)phenyl]-4,6-bis(4-phenyl phenyl)-1,3,5-triazine, and the sebacic acid bis[2,2,6,6-tetramethyl-1-(octyloxy)piperidin-4-yl] were added to and mixed with a mixture of the diethylene glycol dimethacrylate and the caprolactone-modified dipentaerythritol hexaacrylate, to thereby prepare a second photopolymerizable composition (B).

The viscosity of the obtained second photopolymerizable composition (B) at 25° C. was 32 mPa·s. The viscosity was measured with a cone-and-plate rotary viscometer VISCOMETER TV-22 manufactured by Toki Sangyo Co., with the temperature of hemathermal circulating water set to 25° C.

### <<Base Material>>

The base material was a commercially available aluminium foil-laminated polyethylene terephthalate film (ALPET 9-100 manufactured by PANAC Corporation, with a thickness of 100 μm).

### <<Formation of First Layer (A) and Second Layer (B)>>

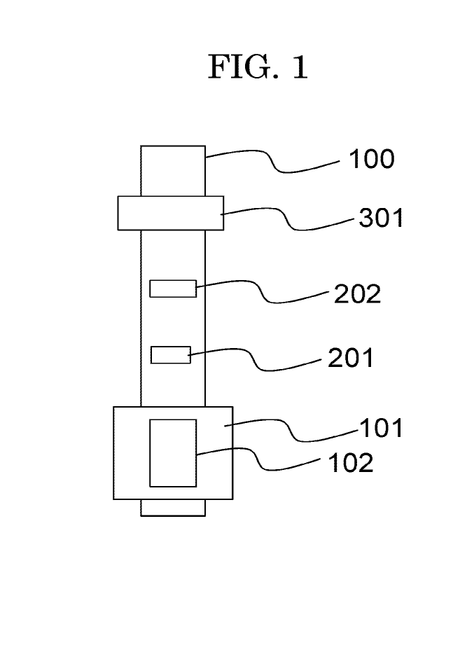

Using the first photopolymerizable composition (A) and the second photopolymerizable composition (B), a first layer (A) and a second layer (B) were formed over an aluminium foil, which was the base material, in a manner described below, with a layered product producing apparatus (an inkjet apparatus) shown in FIG. 1.

The inkjet apparatus shown in FIG. 1 includes a conveying stage 101 configured to travel in a straight line over a linear motion stage 100, and includes a first head 201 configured to jet the first photopolymerizable composition (A), a second head 202 configured to jet the second photopolymerizable composition (B), and a UV lamp 301 along a path of the conveying stage 101.

A base material 102 was fixed over the conveying stage 101, and passed below the first head 201, the second head 202, and the UV lamp 301 by a move of the conveying stage 101. When the base material 102 was passed below the first head 201, the first photopolymerizable composition (A) was jetted over the base material 102 at a desired timing in a desired amount, and a layer made of the first photopolymerizable composition (A) having a desired average thickness was formed over the base material 102.

Then, when the base material 102 was passed below the second head 202, the second photopolymerizable composition (B) was jetted over the base material 102 at a desired timing in a desired amount. Hence, the layer made of the first photopolymerizable composition (A) having the desired average thickness, and above which a layer made of the second photopolymerizable composition (B) having a desired average thickness were formed over the base material 102.

Then, the base material 102 was passed below the UV lamp 301 emitting a desired irradiance level, and the layer made of the first photopolymerizable composition (A) and the layer made of the second photopolymerizable composition (B) over the base material 102 were cured and formed a first layer (A) and a second layer (B) over the base material 102.

The first photopolymerizable composition (A) and the second photopolymerizable composition (B) were applied solidly all over the aluminium foil, which was the base material, by an inkjet manner. After the first photopolymerizable composition (A) was applied, the second photopolymerizable composition (B) was applied without the first photopolymerizable composition (A) being cured, and then the first photopolymerizable composition (A) and the second photopolymerizable composition (B) were cured.

A leveling time of 5 seconds was secured from after the first photopolymerizable composition (A) was applied until before the second photopolymerizable composition (B) was applied, in order for the first photopolymerizable composition (A) to infiltrate all over the base material. A leveling time of 5 seconds was also secured from after the second photopolymerizable composition (B) was applied until before the curing step was started, for infiltration of the second photopolymerizable composition (B). The leveling time may be shorter than 5 seconds or may be equal to or longer than 5 seconds, provided that an infiltrated state could be confirmed by visual observation.

All of the photopolymerizable compositions were inkjet-printed with a GEN 5 head manufactured by Ricoh Company, Ltd., under temperature control for adjusting the viscosity to 11 mPa·s±1 mPa·s.

### —Curing—

The lamp used was SUBZERO 80 D-BULB manufactured by Integration Technology Ltd. The base material and the lamp were placed at a gap of 2 mm, and the base material was conveyed at a speed of 42 mm/s and passed below the lamp four times for curing under the conditions of illuminance of 1.3 W/cm² and a cumulative light volume of 1.01 J/cm² in a wavelength range corresponding to the UVA range. Under these conditions, a total cumulative light volume is 1.0 J/cm²×4 times=4.0 J/cm². However, the cumulative light volume needs only to be at least 1.2 J/cm².

In this way, a layered product of Example 1 was produced.

The average thickness of the first layer (A) and the average thickness of the second layer (B) in the produced layered product were measured in the manner described below. The results are shown in Table 3.

### <Average Thickness of First Layer and Average Thickness of Second Layer>

The average thickness of the first layer and the average thickness of the second layer were each an average of thickness values measured at arbitrary ten positions with a micrometer (manufactured by Mitutoyo Corporation).

The average thickness of the first layer made of the first photopolymerizable composition was previously measured from a layer of the first photopolymerizable composition jetted under the conditions for the first photopolymerizable composition and cured by itself.

The average thickness of the second layer made of the second photopolymerizable composition was obtained by, after applying the first photopolymerizable composition, applying the second photopolymerizable composition under the jetting conditions for the second photopolymerizable composition aiming at the intended thickness, measuring the total average thickness of the first layer and the second layer after cured, and calculating the difference between the total average thickness and the average thickness of the first layer.

Next, “pencil hardness” and “close adhesiveness” of the produced layered product were evaluated in the manners described below. The results are shown in Table 3.

### <Pencil Hardness>

Pencil hardness of the produced layered product was evaluated based on scratch hardness according to a pencil process specified in JIS-K-5600-5-4. The produced layered product was put over a glass plate, and scanned with a pencil in a planar direction. Presence or absence of a scar over the sample was judged by the bare eyes of the observer according to the standard.

The pencils used were a set of wooden drawing pencils having the hardnesses below (manufactured by UNI Mitsubishi Pencil Co., Ltd.).

6B, 5B, 4B, 3B, 2B, B, HB, F, H, 2H, 3H, 4H, 5H, and 6H

### <Close Adhesiveness>

Close adhesiveness to the base material was evaluated according to a crosscut method specified in JIS-K-5600-5-6. A tape peeling test was performed on a grid-like cut that was made into the coating film to include grid squares at 1-mm intervals, and the conditions of any grid squares of the coating film that remained sticked were visually observed and evaluated based on six ranks of from “0” to “5”.

As specified in JIS-K-5600-5-6, “0” indicates a favorable close adhesiveness with no peeling of grid squares, and “1”, “2”, “3”, “4”, and “5” indicate decreasing close adhesiveness in this order.

In this test, “0” with no peeling was evaluated to be A, and “1” to “5” with peeling at all were evaluated to be B.

### Examples 2 to 6 and Comparative Examples 1 to 3

### Production of Layered Products

Layered products of Examples 2 to 6 and Comparative Examples 1 to 3 were produced in the same manner as in Example 1, except that the jetting amounts of the first photopolymerizable composition (A) and the second photopolymerizable composition (B) were changed from Example 1 to achieve the average thickness of the first layer (A) and the average thickness of the second layer (B) shown in Table 3.

With each of the produced layered products, “the average thickness of the first layer (A) and the average thickness of the second layer (B)”, “pencil hardness”, and “close adhesiveness” were evaluated in the same manner as in Example 1. The results are shown in Table 3.

### Examples 7 to 12 and Comparative Examples 4 to 6

### Production of Layered Products

Layered products of Examples 7 to 12 and Comparative Examples 4 to 6 were produced in the same manner as in Example 1, except that the jetting amounts of the first photopolymerizable composition (B) and the second photopolymerizable composition (A) were changed from Example 1 to achieve the average thickness of the first layer (B) and the average thickness of the second layer (A) shown in Table 4.

With each of the produced layered products, “the average thickness of the first layer (B) and the average thickness of the second layer (A)”, “pencil hardness”, and “close adhesiveness” were evaluated in the same manner as in Example 1. The results are shown in Table 4.

TABLE 3

| | | Average | Average | Ratio of | Ratio of | | |
|---|---|---|---|---|---|---|---|
| | Total | thickness | thickness | average | average | | |
| | average | of first | of second | thickness | thickness | | |
| | thickness | layer (A) | layer (B) | of first | of second | Pencil | Close |
| | (μm) | (μm) | (μm) | layer (%) | layer (%) | hardness | adhesiveness |
| Comp. | 38 | 12 | 26 | 32 | 68 | B | B |
| Ex. 1 | | | | | | | |
| Ex. 1 | 50 | 24 | 26 | 48 | 52 | B | A |
| Ex. 2 | 63 | 24 | 39 | 38 | 62 | HB | A |
| Comp. | 76 | 24 | 52 | 32 | 68 | F | B |
| Ex. 2 | | | | | | | |
| Comp. | 89 | 24 | 65 | 27 | 73 | H | B |
| Ex. 3 | | | | | | | |
| Ex. 3 | 68 | 52 | 16 | 76 | 24 | H | A |
| Ex. 4 | 85 | 72 | 13 | 85 | 15 | H | A |
| Ex. 5 | 98 | 72 | 26 | 73 | 27 | 2H | A |
| Ex. 6 | 111 | 72 | 39 | 65 | 35 | 3H | A |

TABLE 4

| | | Average | Average | Ratio of | Ratio of | | |
|---|---|---|---|---|---|---|---|
| | Total | thickness | thickness | average | average | | |
| | average | of first | of second | thickness | thickness | | |
| | thickness | layer (B) | layer (A) | of first | of second | Pencil | Close |
| | (μm) | (μm) | (μm) | layer (%) | layer (%) | hardness | adhesiveness |
| Comp. | 38 | 12 | 26 | 32 | 68 | 2B | B |
| Ex. 4 | | | | | | | |
| Ex. 7 | 50 | 24 | 26 | 48 | 52 | 2B | A |
| Ex. 8 | 63 | 24 | 39 | 38 | 62 | B | A |
| Comp. | 76 | 24 | 52 | 32 | 68 | F | B |
| Ex. 5 | | | | | | | |
| Comp. | 89 | 24 | 65 | 27 | 73 | F | B |
| Ex. 6 | | | | | | | |
| Ex. 9 | 68 | 52 | 16 | 76 | 24 | HB | A |
| Ex. 10 | 85 | 72 | 13 | 85 | 15 | F | A |
| Ex. 11 | 98 | 72 | 26 | 73 | 27 | H | A |
| Ex. 12 | 111 | 72 | 39 | 65 | 35 | H | A |

As can be understood from comparison between Comparative Example 1 and Example 1 based on the results of Table 3, setting the average thickness of the first layer to equal to or greater than 35% of the total average thickness resulted in a favorable close adhesiveness, but in a relatively weak pencil hardness.

As can be understood from comparison among Examples 1 and 2 and Comparative Examples 2 and 3 based on the results of Table 3, a greater average thickness of the second layer resulted in a greater pencil hardness but in a poor close adhesiveness when it made the ratio of the average thickness of the first layer equal to or less than 35% of the total average thickness.

Hence, it turned out that it was possible to obtain a layered product formed of a first layer and a second layer that were non-problematic in skin sensitization, would not corrode a metallic layer, had a high weatherability, and would not easily peel, by forming, over a surface of a metallic layer, a cured film in which the average thickness of the first layer was equal to or greater than 35% of the total average thickness.

As can be understood from comparison among Examples 3 to 6 and Comparative Examples 2 and 3 based on the results of FIG. 3, setting the average thickness of the first layer to equal to or greater than 65% of the total average thickness resulted in a cured film that had a relatively high pencil hardness and a favorable close adhesiveness.

Furthermore, as can be seen from the results of FIG. 4, Examples 7 to 12 and Comparative Examples 4 to 6 obtained similar results to Examples 2 to 6 and Comparative Examples 1 to 3.

Hence, it was possible to obtain a layered product formed of a first layer and a second layer that were non-problematic in skin sensitization, would not corrode metals, had a high weatherability, had a pencil hardness of H or greater, and would not easily peel, by forming, over a surface of a metallic layer, a cured film in which the average thickness of the first layer was equal to or greater than 65% of the total average thickness.

The second layer had a higher pencil hardness (a higher hardness) than that of the first layer, and hence had a greater residual stress due to cure shrinkage than that of the first layer. A second layer having a greater average thickness would have a greater residual stress and be more likely to peel. However, a second layer having a greater average thickness would have a higher pencil hardness.

When the total average thickness of the first layer and the second layer was great, there would be a difference between the surface and the internal region in the intensity at which they would be irradiated during curing. Hence, the surface would be likely to crinkle. Therefore, in consideration of a balance between the total average thickness of the first layer and second layer and the pencil hardness, Example 3 had the most favorable average thickness.

Note that in all of Examples 1 to 12 and Comparative Examples 1 to 6, the second photopolymerizable composition was applied before the first photopolymerizable composition had cured.

In all of Examples 1 to 12, application of the first and second photopolymerizable compositions was performed with an inkjet apparatus.

However, any other application method than the inkjet method may be used, such as brush application and spray coating. However, the inkjet method that can apply a desired thickness in a contactless manner is preferable in the case of applying the second photopolymerizable composition before the first photopolymerizable composition has cured. Furthermore, also in the case where a base material has a complicated shape such as a centrally bored shape rather than a quadrangular flat shape, the inkjet method can apply the photopolymerizable compositions conformally to the complicated shape, and hence can save wasteful consumption of the photopolymeriable compositions at the portions that need no application.

Aspects of the present invention are as follows, for example.

<1> A layered product, including:

a base material; and

a first layer and a second layer over the base material in this order,

wherein the first layer is made of a first photopolymerizable composition that contains at least a polymerizable compound having a hydroxyl group,

wherein the second layer is made of a second photopolymerizable composition that contains at least diethylene glycol dimethacrylate, and

wherein an average thickness of the first layer is equal to or greater than 35% of a total average thickness of the first layer and the second layer.

<2> The layered product according to <1>,

wherein the average thickness of the first layer is equal to or greater than 65% of the total average thickness of the first layer and the second layer.

<3> The layered product according to <1> or <2>,

wherein the average thickness of the first layer is 30 μm or greater.

<4> The layered product according to any one of <1> to <3>,

wherein the base material is a metal or an impermeable base material having a metallic layer at a surface thereof.

<5> The layered product according to any one of <1> to <4>,

wherein the second photopolymerizable composition further contains a hindered amine compound.

<6> The layered product according to any one of <1> to <5>,

wherein a scratch hardness of the layered product according to a pencil process specified in JIS-K-5600-5-4 is H or greater, and a close adhesiveness evaluation of the layered product according to a crosscut method specified in JIS-K-5600-5-6 is “0”.

<7> The layered product according to any one of <1> to <6>,

wherein the polymerizable compound having a hydroxyl group has two or more hydroxyl groups.

<8> The layered product according to any one of <1> to <7>,

wherein the polymerizable compound having a hydroxyl group is glyceryl monomethacrylate.

<9> The layered product according to any one of <1> to <8>,

wherein the second photopolymerizable composition further contains a triazine compound.

<10> A method for producing a layered product, including:

a step of delivering a first photopolymerizable composition containing at least a polymerizable compound having a hydroxyl group onto a base material; and

a step of delivering a second photopolymerizable composition containing at least diethylene glycol dimethacrylate onto a layer made of the first photopolymerizable composition,

wherein a first layer that is a cured product of the first photopolymerizable composition is formed to have an average thickness that is equal to or greater than 35% of a total average thickness.

<11> The method for producing a layered product according to <10>, including:

a step of forming the first layer and a second layer by curing the first photopolymerizable composition and the second photopolymerizable composition.

<12> The method for producing a layered product according to <10> or <11>,

wherein the second photopolymerizable composition is delivered onto the layer made of the first photopolymerizable composition before the layer made of the first photopolymerizable composition is cured.

<13> The method for producing a layered product according to any one of <10> to <12>,

wherein the first photopolymerizable composition and the second photopolymerizable composition are both delivered according to an inkjet method.

<14> A layered product producing apparatus, including:

a first storing unit configured to store a first photopolymerization composition containing at least a polymerizable compound having a hydroxyl group;

a second storing unit configured to store a second photopolymerization composition containing at least diethyelene glycol dimethacrylate;

a first delivering unit configured to deliver the first photopolymerizable composition onto a base material;

a second delivering unit configured to deliver the second photopolymerizable composition onto a layer made of the first photopolymerizable composition; and

a curing unit configured to cure the first photopolymerizable composition and the second photopolymerizable composition that are delivered.

<15> The layered product producing apparatus according to <14>,

wherein the first photopolymerizable composition and the second photopolymerizable composition are both delivered according to an inkjet method.

<16> A layered product material set, including:

a first photopolymerizable composition containing at least a polymerizable compound having a hydroxyl group; and

a second photopolymerizable composition containing at least diethylene glycol dimethacrylate.

This application claims priority to Japanese application No. 2015-044699, filed on Mar. 6, 2015 and incorporated herein by reference.

What is claimed is:

1. A layered product, comprising:
a base material; and
a first layer and a second layer over the base material in this order,
wherein the first layer is made of a first photopolymerizable composition that comprises a polymerizable compound having a hydroxyl group,
wherein the second layer is made of a second photopolymerizable composition that comprises diethylene glycol dimethacrylate, and
wherein an average thickness of the first layer is equal to or greater than 35% of a total average thickness of the first layer and the second layer.

2. The layered product according to claim 1,
wherein the average thickness of the first layer is equal to or greater than 65% of the total average thickness of the first layer and the second layer.

3. The layered product according to claim 1,
wherein the average thickness of the first layer is 30 μm or greater.

4. The layered product according to claim 1,
wherein the base material is a metal or an impermeable base material having a metallic layer at a surface thereof.

5. The layered product according to claim 1,
wherein the second photopolymerizable composition further comprises a hindered amine compound.

6. The layered product according to claim 1,
wherein a scratch hardness of the layered product according to a pencil process specified in JIS-K-5600-5-4 is H or greater, and a close adhesiveness evaluation of the layered product according to a crosscut method specified in JIS-K-5600-5-6 is “0”.

7. The layered product according to claim 1,
wherein the polymerizable compound having a hydroxyl group has two or more hydroxyl groups.

8. The layered product according to claim 1,
wherein the polymerizable compound having a hydroxyl group is glyceryl monomethacrylate.

9. The layered product according to claim 1,
wherein the second photopolymerizable composition further comprises a triazine compound.

10. A method for producing a layered product, comprising:
delivering a first photopolymerizable composition that comprises a polymerizable compound having a hydroxyl group onto a base material; and
delivering a second photopolymerizable composition that comprises diethylene glycol dimethacrylate onto a layer made of the first photopolymerizable composition,
wherein a first layer that is a cured product of the first photopolymerizable composition is formed to have an average thickness that is equal to or greater than 35% of a total average thickness.

11. The method for producing a layered product according to claim 10, comprising:
forming the first layer and a second layer by curing the first photopolymerizable composition and the second photopolymerizable composition.

12. The method for producing a layered product according to claim 10,
wherein the second photopolymerizable composition is delivered onto the layer made of the first photopolymerizable composition before the layer made of the first photopolymerizable composition is cured.

13. The method for producing a layered product according to claim 10,
wherein the first photopolymerizable composition and the second photopolymerizable composition are both delivered according to an inkjet method.

14. A layered product producing apparatus, comprising:
a first storing unit configured to store a first photopolymerization composition that comprises a polymerizable compound having a hydroxyl group;
a second storing unit configured to store a second photopolymerization composition that comprises diethyelene glycol dimethacrylate;
a first delivering unit configured to deliver the first photopolymerizable composition onto a base material;
a second delivering unit configured to deliver the second photopolymerizable composition onto a layer made of the first photopolymerizable composition; and
a curing unit configured to cure the first photopolymerizable composition and the second photopolymerizable composition that are delivered.

15. The layered product producing apparatus according to claim 14,
wherein the first photopolymerizable composition and the second photopolymerizable composition are both delivered according to an inkjet method.
